(19) United States
(12) Patent Application Publication
(10) Pub. No.: US 2007/0101311 A1
(43) Pub. Date: May 3, 2007

(54) Method and system for generating computer-executable models using augmentations

(75) Inventors: Vittorio Castelli, Croton on Hudson, NY (US); Daniel A. Oblinger, Washington, DC (US); Lawrence David Bergman, Mt. Kisco, NY (US)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 11/255,358

(22) Filed: Oct. 21, 2005

(51) Int. Cl. G06F 9/44

(52) U.S. Cl. 717/104

(57) ABSTRACT

A method for incrementally generating a computer-executable model of a procedure from observations of user actions is described. The method includes maintaining a collection of computer-executable procedure models consistent with observed actions of a user, and augmenting the collection when a user action is observed, wherein the user actions are performed while executing a procedure.

### CROSS-REFERENCE TO RELATED APPLICATIONS

This application is related to the following U.S. Patent Applications:

“METHOD AND APPARATUS FOR LEARNING-BY-EXAMPLE AND DISSEMINATING PROCEDURES FOR DESK-SIDE SUPPORT”, filed on Jul. 30, 2003, and having U.S. Ser. No. 10/630,959 (Docket No. YOR920030056US1); “ALIGNMENT AND GENERALIZATION OF DEMONSTRATED PROCEDURE TRACES”, filed on Dec. 5, 2003, and having U.S. Ser. No. 10/729,736 (Docket No. YOR920030355US1); “BIASING HIDDEN MARKOV MODEL LEARNING WITH A SIMILARITY METRIC”, filed on Oct. 22, 2004, and having U.S. Ser. No. 10/972,028, (Docket No. YOR920040289US1),the entire contents of all of the applications, which are assigned to the present assignee, are incorporated herein by reference.

### BACKGROUND OF THE INVENTION

1. Field of the Invention

The invention generally relates to systems and methods for generating and disseminating computer-executable procedures for automation, documentation, and instructional purposes. More specifically, the invention relates to systems and methods for dynamically generating computer-executable, human-readable representation of computer-based procedures in real time by observing actions performed by one or more users on computer applications and responses of the computer applications while performing a specific task.

2. Description of Related Art

Computer-based procedures are pervasive. Examples of such include configuring an application or a software development environment, troubleshooting computer problems, performing repetitive administrative tasks, etc. A procedure is defined as a collection of steps having a well-defined goal. A procedure can have a certain degree of variability due to the state of computer applications, configuration of a computer system, imponderable states of nature, and differences in the details of the goal, to name a few.

As an example of a procedure, consider setting up a meeting. This goal can include several sub-goals such as reserving a conference room, setting up a phone conference, reserving a web conference, and sending invitations to the participants, etc. This procedure has inherent variability as invitees to the meeting can vary depending on the meeting's purpose. Also, the date and time of the meeting can depend on desires of the person calling the meeting. Further, the actual conference room reserved for a meeting can depend on the number of people invited and the capacity of the available conference rooms.

Further variability in a procedure can occur when one or more of the invitees decline the invitation and propose an alternate time for the meeting. In such a scenario, the invitation process may have to be repeated.

Various approaches exist for capturing procedures. One such approach is documentation which provides guidance to a user in performing a task. Another approach is to actually encode the task in a program. Although this approach is effective, it is costly, and is applicable only for a few selected procedures that are widely common. An example of such widely common procedure is installation of a software package, which is typically performed with the assistance of an installation wizard. Automation is also possible using scripts in ad-hoc languages (e.g., Perl, Python). However, the automation using scripting languages is typically limited to automating command-line tasks, such as certain types of system-administration operations, and does not work on graphical user interfaces (GUI).

Automation is also possible via macros which operate within a single program, or even across applications and directly on GUIs. Macros are constructed either with a scripting language or by observing the user performing a task and creating a task representation that can be re-executed at a later time. One disadvantage of scripts and macros is brittleness. Macros typically fail to successfully complete when variations in the computer environment and configuration occur. Such can also be true for scripts, unless the scripts are written to compensate for such variability. If scripts are written in such manner to account for variability, then they can become equivalent to a full-fledge program resulting in high development and maintenance cost.

GUI macro recorders also suffer from additional limitations. For example, such macro recorders work only for straight-line procedures (e.g., they can repeat the steps that a user demonstrated, in the same order, but cannot capture variability such as the existence of sub-tasks that depend on conditions detectable from the displayed content). Additionally, the macro readers are typically limited in the ability of parameterizing the task to account for the variability resulting from user preferences and desires.

Other disadvantages associated with conventional methods that use scripted procedures or documentation is that such methods suffer from obsolescence. For example, as newer versions of operating systems, applications, and hardware components become available, scripted procedures must be updated to accommodate the newer versions and such updates are often costly. Similarly, instructive documentation may have to be appropriately revised by adding new sections thereby causing further confusion for the end users.

Methods for overcoming such difficulties using programming-by-demonstration techniques are taught in the co-pending patent applications “Method and apparatus for learning-by-example and disseminating procedures for desk-side support”, “Alignment and generalization of demonstrated procedure traces”, and “Biasing hidden Markov model learning with a similarity metric” as listed above.

These co-pending patent applications disclose, among other things, that multiple recordings of executions of a single procedure by one or more users are combined in an executable procedure model. Some of the drawbacks of the methods described in the aforementioned patent applications are that they are off-line methods (e.g., the procedure is updated after the data is collected), and the methods produce an opaque procedure representation (e.g., a procedure that cannot be easily converted into a human-readable form.

Therefore, there is a need to overcome the above-noted problems.

### SUMMARY OF THE INVENTION

An embodiment of the invention relates to constructing human-readable procedure models in real-time from demonstration of procedure executions. Specifically, aspects of the invention describe a method for incrementally constructing executable procedure models from multiple demonstrations having features of incrementally constructing the model while a user performs the task, and of producing a human-readable procedure representation. For example, the procedure can resemble a “pseudo-program” or an actual program.

In one aspect, a method for incrementally generating a computer-executable model of a procedure from observations of user actions is described. The method includes maintaining a collection of computer-executable procedure models consistent with observed actions of a user, and augmenting the collection when a user action is observed, wherein the user actions are performed while executing a procedure.

In another aspect, a computer-implemented method for incrementally generating a model of a procedure from observations includes maintaining a collection of a procedure model that is consistent with observed actions of a user, and augmenting the maintained collection when a user action is observed, wherein the user actions are performed while executing a procedure.

### BRIEF DESCRIPTION OF THE DRAWINGS

Preferred embodiments of the invention are described below with reference to the following accompanying drawings.

FIG. 1 is an exemplary flow chart for incrementally updating a procedure model.

FIG. 2 is an exemplary flow chart for incrementally updating in real-time a procedure model using augmentations in accordance with various embodiments of the invention.

FIG. 3 is an exemplary flow chart for replicating actions performed on a computer in accordance with an embodiment of the invention.

FIG. 4 is an exemplary flow chart for identifying a minimal description uniquely identifying a user-interface (UI) component on a computer in accordance with an embodiment of the invention.

FIG. 5 illustrates a computer system for implementing various aspects of the invention.

### DETAILED DESCRIPTION OF THE PREFERRED EMBODIMENTS

DEFINITIONS

The following terms and abbreviations have been used herein:

UI stands for “user interface”;

GUI is an abbreviation for “Graphical User Interface”;

Widget denotes any component of the user interface with which the user can interact. The term GUI element is also similarly used.

A Procedure is defined as a collection of steps having a well-defined goal. Each step is defined to be an interaction with one or more computer applications. Tasks where the final goal cannot be precisely specified in terms of a small number of user decisions and of variability (e.g., in the environment, state of a computer and of the computer applications) that is apparent as displayed on a computer monitor may not be considered procedures. For example, writing a patent application, a letter, chatting on line, and writing a program are not considered procedures as it would be difficult to specify a priori the actual process and the final result.

Various aspects have been described in reference to a generic human-readable representation. It will be appreciated that the methods taught herein can be extended to other representations having equivalent expressive power. The procedure representation used in the preferred embodiment includes a collection of nested elements, called procedure steps or just steps. The following types of steps are distinguished as follows:

Action step is a step describing an action performed by a user during one of the demonstrations. Action steps can be parameterized. A special type of action step is the “end procedure” step, which denotes that the procedure has completed.

Block is a collection of steps performed sequentially in the order in which they appear in the block. The steps in a block can be of any of the types described here.

Conditional branch step is a step having at least two blocks and various conditions equal to the number of blocks. These conditions are Boolean expressions on appropriate variables, and satisfy the requirement that for each possible set of values of the variables, one of the expressions should preferably evaluate to true and all the others preferably evaluate to false. One of the conditions is allowed to be a “default” conditions, namely a condition that depends only on the values of the other conditions, and evaluates to true if and only if none of the other conditions evaluate to true.

The semantics of a conditional branch step are as follows: when executing a conditional branch step, the block corresponding to the condition that evaluates to true is executed.

Unconditional branch step is a step having at least two blocks, describing alternative paths that could be taken non-deterministically, namely for which no conditions exist that indicate which block should be executed.

Loop step is a step having a condition and a block. The block is executed as long as the condition is true. The condition could be evaluated before executing the block, or after executing the block. It will be appreciated that these two different types of blocks correspond respectively to the while (or for) and to the do . . . while statements common to a variety of programming languages.

A procedure can be represented by nesting various. At a high level, the procedure can be considered to be just a block (e.g., root block). Steps within the root block can be other blocks, action steps, loops, and branches.

The procedure representation can be automatically executed by performing the steps in the order dictated by the procedure structure. Initially, a first step of the root block is identified. If this step is an action step, it is executed. If it is a conditional branch, the conditions are evaluated and the block corresponding to the true condition is executed. If it is an unconditional branch, one of its blocks is selected at random, and executed. If it is a “while” loop, its condition is evaluated, and if it is true, the loop block is executed, and so on and so forth. Execution terminates when an “end procedure” step is encountered. A path through a procedure is a sequence of action steps starting at the beginning of the procedure and ending with an “end procedure” step, consistent with the above described way of executing the procedure.

Various aspects of the invention disclose a method for incrementally updating the structure of a procedure using augmentations. An augmentation is a structural change of an existing procedure model P1, that yields a procedure model P2 that satisfies the following constraints:

1) every allowable path of P1 is an allowable path in P2.

2) the structure of P1 is a subset of the structure of P2 (e.g., the structure of P1 can be obtained by removing one or more steps from P2).

Removing a step from a procedure model structure is defined as follow: removing an action step means discarding the action step. Removing a loop means removing the condition and the block but retaining all the steps within the block and using the steps to replace the loop step. Removing a block means substituting the block with the steps included in the block. A branch step can be removed only if it has two alternative paths (e.g., blocks). Where one of the blocks is empty, removing the branch step means removing all the conditions and the blocks, and substituting the branch step with the content of the non-empty block.

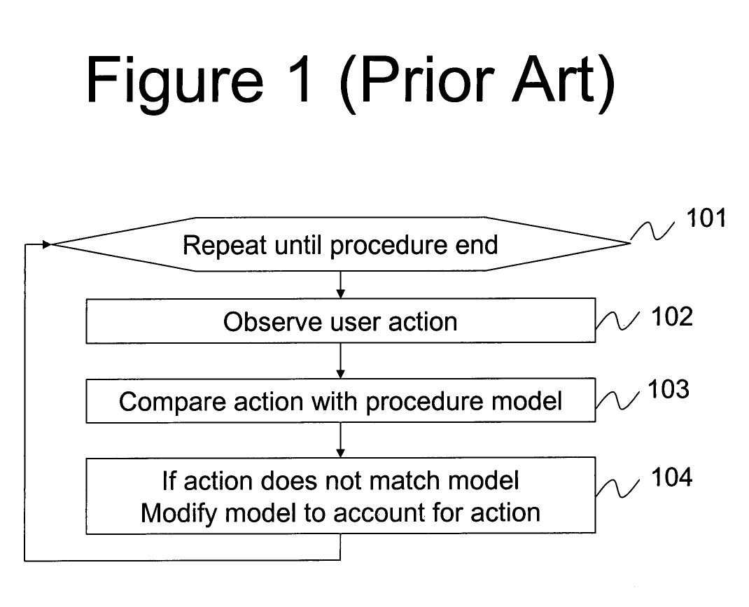

Referring to FIG. 1, an exemplary flow chart for incrementally updating a procedure model is disclosed.

At a step 101, it is ensured that steps 102 to 104 are performed until a user terminates task execution.

At a step 102, the user action and system reaction are observed.

At a step 103, the observed action is compared with a procedure model.

At a step 104, if the action does not match the procedure model, the model is modified to account for the observed action.

In the event of a mismatch between the observed user action and the procedure model, one possible solution can be to rebuild the entire procedure model from scratch using various examples of task execution and the task that is being currently executed by the user. The computational cost makes such a solution unsuitable for real-time applications.

In general, given a procedure model and a new observed action, there can be multiple augmentations that are consistent with the procedure model and the new observed action. The method illustrated in FIG. 1 fails to consider this property and therefore is not suitable for use with augmentations.

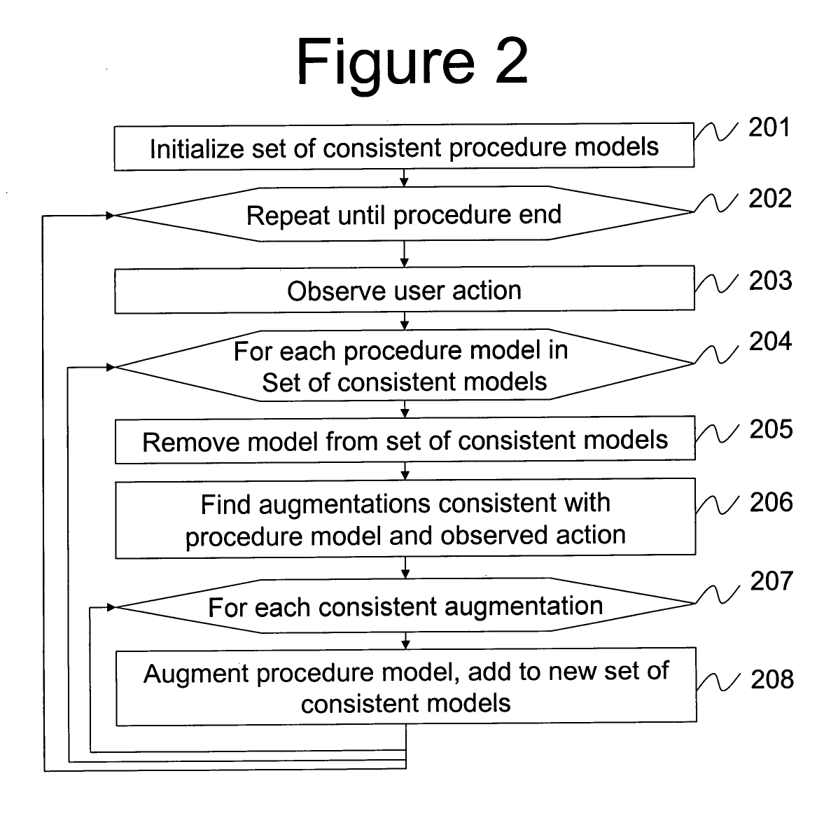

FIG. 2 is an exemplary flow chart for incrementally updating in real-time a procedure model using augmentations in accordance with various embodiments of the invention.

At a step 201, a set of consistent procedure models are initialized. At a step 202, the initialization procedure is repeated until the end of the procedure.

At a step 203, a user action is observed.

At steps 204 and 205, for each procedure model in a set of consistent procedure models, the procedure model is removed from the set of consistent procedure models.

At a step 206, augmentations that are consistent with the removed procedure model and the observed user action are identified.

At steps 207 and 208, for each consistent augmentation, the removed procedure model is augmented and the resulting new model added to a new set of consistent models.

The methodology of FIG. 2 can become expensive if all possible augmentations are allowed. In a preferred embodiment, allowed augmentation types are limited, to prevent augmentations that create a new path from a step that is not a last step of a block, to a step that is not the first step of another block. The allowed augmentations include the following:

NO_UPDATE: this augmentation leaves the structure of the procedure model unchanged. Table I is an example of no-update augmentation that leaves the previous procedure model unchanged, and only updates the pointer to the current step.

TABLE I

| Previous | | New Procedure |
|---|---|---|
| Procedure Model | | Model |
| (last procedure | Observed | (current procedure |
| step in bold) | User Action | step in bold) |
| Click on Start−>Settings | | Click on Start−>Settings |
| Click on Control Panel | | Click on Control Panel |
| Click on System | Click on System | Click on System |
| Click on | | Click on |
| “Computer Name” | | “Computer Name” |

SKIP_INTRODUCTION: this augmentation introduces a new direct path from a step to a subsequent step in the same block, from a step to the end of the block, or from a step that immediately precedes a block to a step within the block. It is called a “skip” because this path “skips” over other steps. This augmentation can cause the introduction of a branch, or of a path in an existing branch, depending on the structure of the procedure.

The following example as shown in Table II is based on a continuation of the procedure described in the NO_UPDATE example:

TABLE II

| Previous | | New Procedure |
|---|---|---|
| Procedure Model | | Model |
| (last procedure | Observed | (current procedure |
| step in bold) | User Action | step in bold) |
| Click on | | Click on |
| “Computer Name” | | “Computer Name” |
| Click on Change | | Click on Change |
| Select Domain | Type | [symbol] |

| | |
|---|---|
| Watson.ibm.com | [symbol] |

[symbol]

[symbol]

| | |
|---|---|
| Type Watson.ibm.com | [symbol] |

[symbol]

[symbol]

[symbol]

Type Watson.ibm.com

In the example illustrated in Table II, the introduced skip step is shown in bold and italicized.

LOOP INTRODUCTION: this augmentation groups a sequence of steps into a block, and associates a loop condition with the block.

The following example shown in Table III illustrates a user operating on a list of files called file1.txt, file2.txt, etc.

TABLE III

| Previous | | New Procedure |
|---|---|---|
| Procedure Model | | Model |
| (last procedure | Observed | (current procedure |
| step in bold) | User Action | step in bold) |
| Right click on | | [symbol] |
| file1.txt | | [symbol] |
| Select “Rename” | | [symbol] |

| | |
|---|---|
| Type “file1.doc” | [symbol] |

| | |
|---|---|
| Right click on | [symbol] |
| file2.txt | [symbol] |

[symbol]

In Table III, the terms shown within brackets denote iteration variables.

BRANCH INTRODUCTION: this augmentation adds a new path to an existing branch, or blocks a group of steps into a block, creates a second block to which an action step corresponding to the most recently observed user action is added, and creates conditions that govern which path is taken. Branch introduction is an extension of SKIP INTRODUCTION.

OPEN_BLOCK_EXTENSION: this augmentation adds a new action step to a block that is incrementally created when novel action steps are added as a consequence of observing new user actions, an example of which is shown in Table IV.

TABLE IV

| Previous | | New Procedure |
|---|---|---|
| Procedure Model | | Model |
| (last procedure | Observed | (current procedure |
| step in bold) | User Action | step in bold) |
| BLOCK: | | BLOCK: |

| | | |
|---|---|---|
| Click on | | Click on |
| “Computer Name” | | “Computer Name” |
| Click on Change | | Click on Change |
| Select Domain | Type | Select Domain |

| END BLOCK | Watson.ibm.com | Type |
|---|---|---|
| | | Watson.ibm.com |

END BLOCK

BRANCH TERMINATION: this augmentation is generated after a new branch step is created at the point in which the inference algorithm can determine where the different paths in the branch merge. An example of BRANCH TERMINATION is shown in Table V.

TABLE V

| Previous | | New Procedure |
|---|---|---|
| Procedure Model | | Model |
| (last procedure | Observed | (current procedure |
| step in bold) | User Action | step in bold) |
| Click on | | Click on |
| “Computer Name” | | “Computer Name” |
| Click on Change | | Click on Change |
| If Domain is | Type | [symbol] |

| not selected | | Watson.ibm.com | [symbol] |
|---|---|---|---|
| | Select Domain | | [symbol] |

| | |
|---|---|
| END BLOCK | [symbol] |

| | |
|---|---|
| Else | [symbol] |

| | |
|---|---|
| BLOCK: | [symbol] |

| | |
|---|---|
| Type | [symbol] |

| | |
|---|---|
| Watson.ibm.com | [symbol] |
| Click OK | |

END BLOCK

Type Watson.ibm.com
Click OK

It will be appreciated that a different choice of allowed augmentations can be selected while not deviating from the inventive concepts.

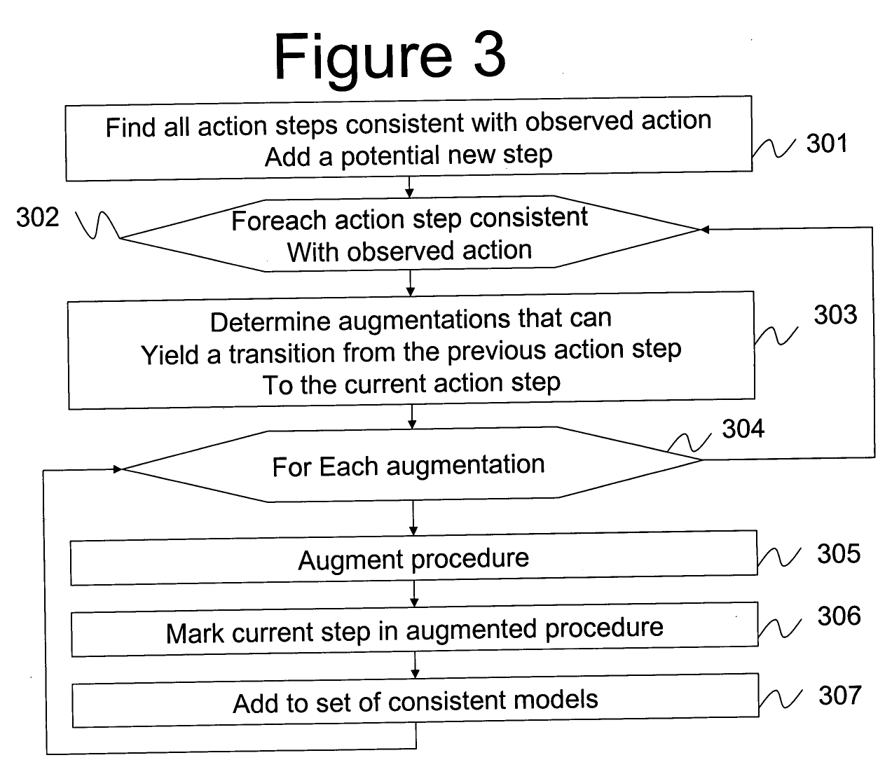

FIG. 3 is an exemplary flow chart for replicating actions performed on a computer in order to find augmentations that are consistent with the procedure model and the observed user action as described in FIG. 2.

At a step 301, all action steps in the procedure model that are consistent with the observed action are identified. For example, if the user clicks on a button labeled “Ok”, step 301 finds all the action steps in the procedure model that were created in response to the observation of a user click on a button labeled “Ok”. In another embodiment, an indexing mechanism (e.g., database indexing) can be used to identify the action steps in the procedure model that are consistent with the observed user action. Step 302 iterates over steps 303 to 307.

For each of the action steps identified in step 301, steps 303 to 307 are executed.

At a step 303, a determination is made if there is an augmentation that modifies the procedure model to yield a direct transition from a previous action step and the currently selected action step.

If no such augmentation exists, step 304 returns control to step 302, which selects the next action step consistent with the observed action, or terminates the execution if all consistent action steps have been iterated upon. Otherwise, step 304 iterates over all augmentations produced by step 303, and the computation proceeds to step 305.

Step 305 augments the procedure, hence constructing a new procedure model.

At a step 306, the current action step is marked in the new procedure model, and becomes the previous action step when the next user action is observed for which the methodology of FIG. 3 is applied.

In step 307, the new procedure model is added to the set of consistent models to be analyzed during the next iteration of steps 202 to 208 (FIG. 2). Note that steps 305, 306, and 307 correspond to step 208 in FIG. 2.

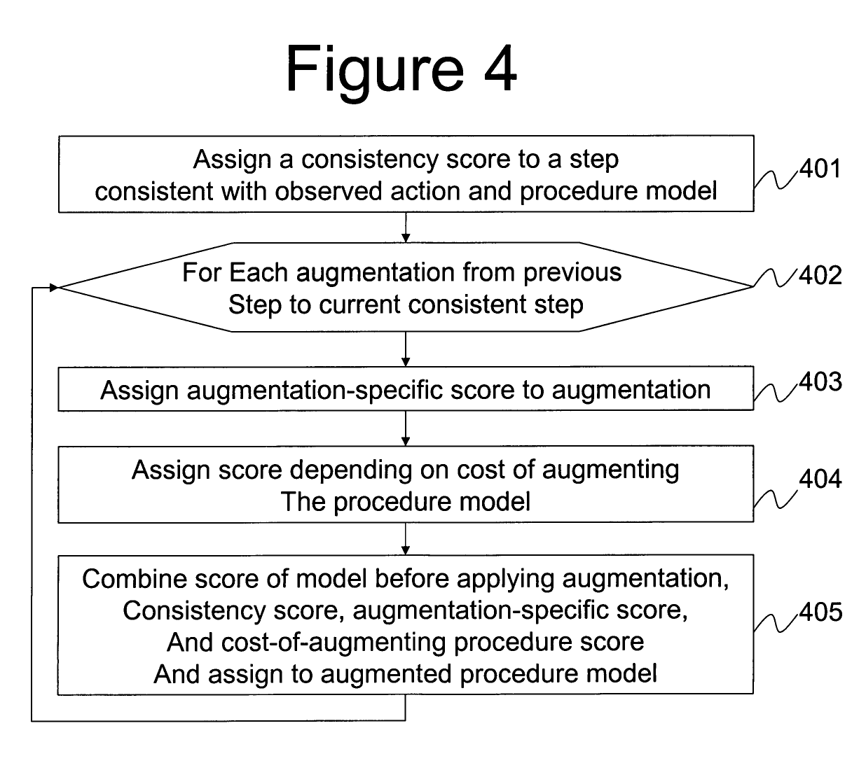

The methodology described in FIG. 2 and FIG. 3 yields a multiplicity of procedure models that are consistent with an initial procedure model and the sequence of actions being demonstrated by the user. In a preferred embodiment, these procedure models are ranked using a score, and the procedure model with best score is visually displayed for the user. In a preferred embodiment, the score is computed using the methodology described in FIG. 4.

Referring to FIG. 4, step 401 can be executed in conjunction with step 303 (FIG. 3) in one embodiment. At a step 401, a score is associated to each step consistent with the observed action. This score reflects the degree of consistency. For example, if lower scores are better, a score of 0 can be used to reflect exact match, a score of 1 could reflect the fact that the step seems to describe an alternate way of performing the same action, etc.

Step 402 is analogous to Step 304. In an embodiment where the methodology of FIGS. 3 and 4 are applied simultaneously, steps 304 and 402 can be merged.

At a step 403, an augmentation-specific score is assigned to each augmentation.

Step 404 can be performed in conjunction of Step 305, and assigns a score to an augmentation depending on the type of augmentation. For example, if lower scores are. better, an augmentation that requires no change to the procedure structure is assigned the smallest score (e.g., 0), while an augmentation that requires a big change, such as the introduction of a loop, would have a high score.

At the step 404, the designer of a system can influence the behavior of the system by selecting specific scores to assign to specific augmentations. For example, if the designer favors a compact procedure representation, small scores can be assigned to loops and branches, and higher scores to open block extensions. A designer favoring a more readable and less compact representation would probably make the opposite decision.

Step 405 is preferably executed after the completion of step 305 (FIG. 3), considering the cost of augmenting the procedure with the selected augmentation. This cost could be fixed for simple augmentations like, for example, NO_AUGMENTATION (e.g., cost=0) and OPEN_BLOCK_EXTENSION, but could be a variable cost for LOOP_INTRODUCTION, BRANCH_INTRODUCTION and SKIP_INTRODUCTION.

Consider, for example, the introduction of a branch that requires identifying the Boolean expressions that determine which path through the branch should be followed when executing the procedure. These expressions are constructed by comparing representations displayed on a display device (e.g., monitor) and information known to the user just prior to the first actions in each of the paths. It will be appreciated that the user typically makes different decisions depending on the user's knowledge and also based on what is visible on the display device.

Often, it is possible to infer simple Boolean expressions. For example, one could infer that the user checks a certain check box if it is not already checked, and leaves it untouched otherwise. Here, it is natural to give a good score to the process of augmenting the procedure, because the process gives rise to a simple explanation of the user actions. However, if the inferred Boolean expressions are complex, the score can be worse. However, if the instantiation process cannot yield a good explanation of the user actions, the score can be extremely poor.

Step 405 combines the scores computed in step 401, step 403, and step 404 with the score of the procedure model before it is augmented, and assigns the resulting score to the augmented procedure. If lower scores are better, a simple way of combining the costs can be obtained by adding scores.

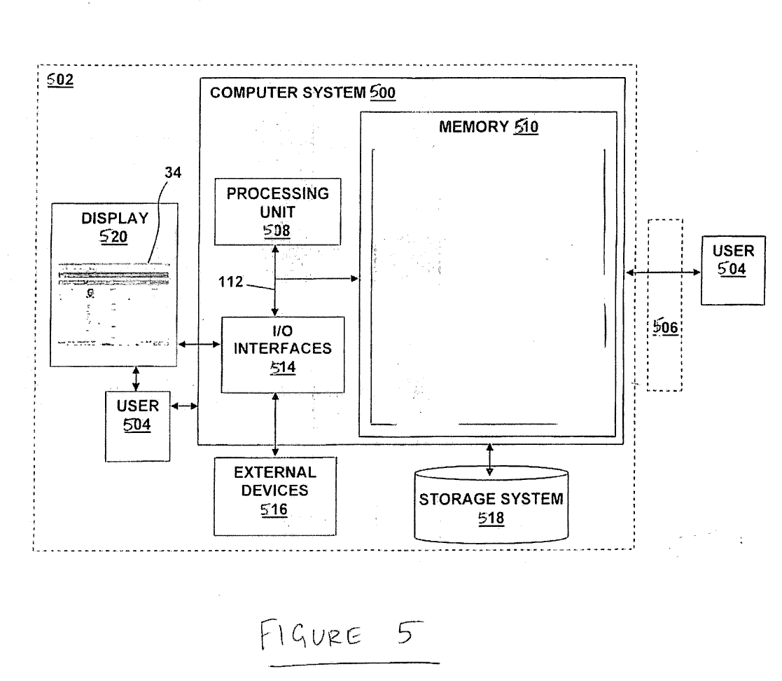

FIG. 5 illustrates a computer system for implementing various aspects of the invention.

Computer system 500 is provided in a computer infrastructure 502. Computer system 500 is intended to represent any type of computer system capable of carrying out the teachings of the present invention. For example, computer system 500 can be a laptop computer, a desktop computer, a workstation, a handheld device, a server, a cluster of computers, etc. In addition, as will be further described below, computer system 500 can be deployed and/or operated by a service provider that provides a service for constructing transparent procedure models from multiple demonstrations using augmentations in accordance with the present invention. It should be appreciated that a user 504 can access computer system 500 directly, or can operate a computer system that communicates with computer system 500 over a network 506 (e.g., the Internet, a wide area network (WAN), a local area network (LAN), a virtual private network (VPN), etc). In the case of the latter, communications between computer system 500 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Computer system 500 is shown including a processing unit 508, a memory 510, a bus 512, and input/output (I/O) interfaces 514. Further, computer system 500 is shown in communication with external devices/resources 516 and one or more storage systems 518. In general, processing unit 508 executes computer program code, such as for constructing transparent procedure models, that is stored in memory 510 and/or storage system(s) 518. While executing computer program code, processing unit 508 can read and/or write data, to/from memory 510, storage system(s) 518, and/or I/O interfaces 514. Bus 512 provides a communication link between each of the components in computer system 500. External devices/resources 516 can comprise any devices (e.g., keyboard, pointing device, display (e.g., display 520, printer, etc.) that enable a user to interact with computer system 500 and/or any devices (e.g., network card, modem, etc.) that enable computer system 500 to communicate with one or more other computing devices.

Computer infrastructure 502 is only illustrative of various types of computer infrastructures that can be used to implement the present invention. For example, in one embodiment, computer infrastructure 502 can comprise two or more computing devices (e.g., a server cluster) that communicate over a network (e.g., network 506) to perform the various process steps of the invention. Moreover, computer system 500 is only representative of the many types of computer systems that can be used in the practice of the present invention, each of which can include numerous combinations of hardware/software. For example, processing unit 508 can comprise a single processing unit, or can be distributed across one or more processing units in one or more locations, e.g., on a client and server. Similarly, memory 510 and/or storage system(s) 518 can comprise any combination of various types of data storage and/or transmission media that reside at one or more physical locations. Further, I/O interfaces 514 can comprise any system for exchanging information with one or more external devices/resources 516. Still further, it is understood that one or more additional components (e.g., system software, communication systems, cache memory, etc.) not shown in FIG. 5 can be included in computer system 500. However, if computer system 500 comprises a handheld device or the like, it is understood that one or more external devices/resources 516 (e.g., display 520) and/or one or more storage system(s) 518 can be contained within computer system 500, and not externally as shown.

Storage system(s) 518 can be any type of system (e.g., a database) capable of providing storage for information under the present invention. To this extent, storage system(s) 518 can include one or more storage devices, such as a magnetic disk drive or an optical disk drive. In another embodiment, storage system(s) 518 can include data distributed across, for example, a local area network (LAN), wide area network (WAN) or a storage area network (SAN) (not shown).

Moreover, although not shown, computer systems operated by user 504 can contain computerized components similar to those described above with regard to computer system 500.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read—only memory (ROM), rigid magnetic disk and optical disk. Current examples of optical disks include a compact disk-read only disk (CD-ROM), a compact disk—read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A method for incrementally generating a computer-executable model of a procedure from observations of user actions, the method comprising:
maintaining a collection of computer-executable procedure models consistent with observed actions of a user; and
augmenting the collection when a user action is observed, wherein the user actions are performed while executing a procedure.

2. The method of claim 1, wherein the augmenting comprises:
identifying at least one augmentation that is consistent with at least one of the computer-executable procedure models and the observed user action; and
applying the identified at least one augmentation to the at least one computer-executable procedure model to produce a new executable procedure model, the new executable procedure model being consistent with the at least one computer-executable model and the observed user action.

3. The method of claim 2, wherein the identifying comprises:
identifying action steps in the at least one of the computer-executable procedure model, the action steps being consistent with the observed user action;
creating a new action step that is consistent with the observed user action;
determining augmentations configured to produce a transition from a previous action step to each of the identified action steps; and
determining augmentations configured to produce a transition from the previous action step to the new action step.

4. The method of claim 3, further comprising:
for each of the determined augmentations, marking a step to which the determined augmentation produces a transition to become the previous action step.

5. The method of claim 3, further comprising:
assigning a consistency score to each of the identified action steps;
assigning an augmentation-specific score to each of the determined augmentations; and
assigning a cost score to a cost of applying each of the determined augmentations.

6. The method of claim 5, further comprising:
assigning a score to each of the computer-executable procedure models; and
displaying to a user a computer-executable procedure model with an optimum score.

7. The method of claim 6, further comprising:
combining the consistency score, the augmentation-specific score, and the cost score with the score assigned to each of the computer-executable procedure model to produce a combined score for each of the computer-executable models; and
assigning the combined score to the new executable procedure model that is consistent with the computer-executable procedure model and the observed user action.

8. A computer-implemented method for incrementally generating a model of a procedure from observations of user actions, the method comprising:
maintaining a collection of a procedure models consistent with observed actions of a user; and
augmenting the collection when a user action is observed, wherein the user actions are performed while executing a procedure.

9. The computer-implemented method of claim 8, wherein the augmenting comprises:
identifying at least one augmentation that is consistent with at least one of the procedure models and the observed user action; and
applying the identified at least one augmentation to the at least one procedure model to produce a new executable procedure model, the new executable procedure model being consistent with the at least one procedure model and the observed user action.

10. The computer-implemented method of claim 9, wherein the identifying comprises:
identifying action steps in the procedure model that are consistent with the observed user action;
creating a new action step that is consistent with the observed user action;
determining augmentations configured to produce a transition from a previous action step to each of the identified action steps; and
determining augmentations configured to produce a transition from the previous action step to the new action step.

11. The computer-implemented method of claim 9, further comprising:
for each of the determined augmentations, marking a step to which the determined augmentation produces a transition to become the previous action step.

12. The computer-implemented method of claim 9, further
comprising:
assigning a consistency score to each of the identified action steps;
assigning an augmentation-specific score to each of the determined augmentations; and
assigning a cost score to a cost of applying each of the determined augmentations.

13. The computer-implemented method of claim 12, further comprising:
assigning a score to each of the procedure models; and
displaying to a user a procedure model with an optimum score.

14. The method of claim 13, further comprising:
combining the consistency score, the augmentation-specific score, and the cost score with the score assigned to each of the procedure models to produce a combined score for each of the procedure models; and
assigning the combined score to the new executable procedure model that is consistent with the at least one procedure model and the observed user action.

15. A computer program product stored on a computer useable medium for incrementally generating a model of a procedure from observations of user actions, the computer useable medium comprising program code for causing a computer system to perform the following steps:
maintaining a collection of a procedure models consistent with observed actions of a user; and
augmenting the procedure models when a user action is observed, wherein the user actions are performed while executing a procedure.

16. The computer program product of claim 15, wherein the augmenting comprises:
identifying at least one augmentation that is consistent with at least one of the procedure models and the observed user action; and
applying the identified at least one augmentation to the at least one procedure model to produce a new executable procedure model, the new executable model being consistent with the at least one procedure model and the observed user action.

17. The computer program product of claim 16, wherein the identifying comprises:
identifying action steps in the procedure models that are consistent with the observed user action;
creating a new action step that is consistent with the observed user action;
determining augmentations configured to produce a transition from a previous action step to each of the identified action steps; and
determining augmentations configured to produce a transition from the previous action step to the new action step.

18. The computer program product of claim 17, further comprising:
for each of the determined augmentations, marking a step to which the determined augmentation produces a transition to become the previous action step.

19. The computer program product of claim 17, further comprising:
assigning a consistency score to each of the identified action steps;
assigning an augmentation-specific score to each of the determined augmentations; and
assigning a cost score to a cost of applying each of the determined augmentations.

20. The computer program product of claim 19, further comprising:
assigning a score to each of the procedure models; and
displaying to a user a procedure model with an optimum score.

21. The computer program product of claim 20, further comprising:
combining the consistency score, the augmentation-specific score, and the cost score with the score assigned to each of the procedure models to produce a combined score for each of the procedure models; and
assigning the combined score to the new executable procedure model that is consistent with the at least one procedure model and the observed user action.
